(19) United States
(12) Patent Application Publication
(10) Pub. No.: US 2012/0160341 A1
(43) Pub. Date: Jun. 28, 2012

(54) Coupling and decoupling apparatus and method

(76) Inventor: Thomas F. Moran, Twinsburg, OH (US)

(21) Appl. No.: 13/134,235

(22) Filed: Jun. 2, 2011

Related U.S. Application Data
(60) Provisional application No. 61/426,866, filed on Dec. 23, 2010.

(51) Int. Cl. B23P 19/00; B21C 23/24

(52) U.S. Cl. 137/315.01; 72/46

(57) ABSTRACT

A coupling apparatus with a central housing with an outer surface and an inner surface that forms a central bore sized to receive an end of a first conduit length and an end of a second conduit length. The coupling apparatus further comprises a first and a second flexible support arm with respective first and second arm openings that have respective first and second arm spring elements. There are a plurality of first arm teeth and a plurality of second arm teeth that engage with and grip an end of a first conduit length and second conduit length. The bonding and/or grounding effectiveness increases when a tensile force placed on the coupling apparatus increases by separating the first conduit length from the second conduit length.

### FIELD OF THE INVENTION

The invention relates generally to a coupling and decoupling apparatus and method capable of providing easily adjustable coupling of at least two components and more specifically to an easily adjustable apparatus and method of electrical metallic conduit coupling and uncoupling.

### BACKGROUND OF THE INVENTION

The present invention relates to an apparatus and method for quickly and easily coupling EMT conduit together.

A prior art expansion coupling 20 illustrated in FIG. 1 is taught by U.S. Pat. No. 7,005,574 to Burnette (illustrated in the Burnette patent as FIG. 5). The prior art apparatus 20 is utilized for connecting lengths of electric metallic tubing (EMT). The prior art apparatus 20 uses a coupling that has barbs 25 designed to engage corresponding indentations on EMT (not shown) to ensure proper installation. In addition, the prior art apparatus 20 has threaded bolts to ‘lock’ the apparatus 20 to the EMT. However, the apparatus device suffers many limitations. In the event that the apparatus 20 and the end of an EMT coupling segment have to be separated, the barb interference fit makes it very difficult to separate them. In addition, it is difficult to determine if the EMT is properly coupled in place because there is no indication that the bolts are locked properly with sufficient torque or even locked at all. In addition, the expansion coupling 20 is expensive to manufacture.

Yet another prior art coupling 20 is illustrated in FIG. 2 that is taught by U.S. Pat. No. 6,988,746 to Olson (illustrated in the Olson patent as FIG. 3). In FIG. 2, the prior art coupling 20, incorporates raised wrench flats 24 which require the coupling to be stabilized with a wrench when installing conduit. Obviously it would be an advantage over this prior art to have a coupling that does not require tools to install. In addition, the coupling is made up of numerous components that can be misplaced or lost during installation and the prior art expansion coupling 20 is expensive to manufacture.

Therefore there remains a need for a coupling that is inexpensive to manufacture, requires little effort to install, skill, or tools to install and remove, that has few components and that is easily inspected to determine if it installed properly.

### SUMMARY OF THE INVENTION

Accordingly, the present invention overcomes the limitations of the prior art by providing a unique and useful coupling and decoupling apparatus capable of providing a visual indication that an EMT conduit length is properly ‘locked’ in place, that is easy to apply and remove from the EMT conduit, and a method of using such an apparatus.

Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

It is an object of the present invention to provide a new and improved coupling apparatus and method that provides visual indication that an EMT conduit length is properly ‘locked’ in place.

It is a further object of this invention to present a coupling apparatus and method that allows both easier coupling and uncoupling of EMT conduit.

It is an object of the present invention to provide a more economical coupling apparatus and method that attaches easily and safely to an EMT conduit length with little effort or skill.

It is yet another object of this invention to provide a coupling apparatus and method that is usable on a variety of non-fixedly attached components, such as for example, water hose connections, spliced metal cable, spliced ropes, vacuum hoses, quick release tools, concrete conduit length and the like.

It is yet a further object of the present invention that the coupling apparatus and method can be used to couple and/or uncouple an EMT conduit length without the use of tools.

It is an additional object of the invention to utilize friction to hold the coupling apparatus in place while still allowing for expansion/contraction of EMT conduit.

It is yet another object of this invention to provide a coupling apparatus and method wherein bonding and/or grounding effectiveness increases when pulling force on the EMT conduit sections is applied to the coupling apparatus.

It is another object of this invention to provide a coupling apparatus comprising a flange and mounting holes and method wherein the coupling apparatus can be fastened to or hung on a wall, ceiling, structural surface, and the like.

It is another object of this invention to provide a coupling apparatus and method wherein the coupling apparatus can be stamped and formed from a single piece of flat stock.

It is another object of this invention to provide a coupling apparatus and method wherein the coupling apparatus can be manufactured to be water tight, concrete tight, and the like.

It is another object of this invention to provide a coupling apparatus and method wherein a first opening and a second opening of the coupling apparatus are equal in size and/or shape.

Yet another object of this invention is to provide a coupling apparatus and method wherein a first opening and a second opening of the coupling apparatus are not equal in size and/or shape.

It is another object of this invention is to provide a coupling apparatus and method wherein a first opening and a second opening can comprise a circular shape, a rectangular shape, an oval shape and the like.

It is another object of this invention is to provide a coupling apparatus and method wherein the coupling apparatus can join metal components, concrete components, wooden components and the like.

It is another object of this invention is to provide a coupling apparatus and method wherein the coupling apparatus material comprises metal, conductive plastic, plastic, composites, and the like.

### BRIEF DESCRIPTION OF THE DRAWINGS

Embodiments of the invention will now be described with reference to the accompanying drawings.

FIG. 1 illustrates a side view of a prior art coupling apparatus with, threaded fasteners and barbs for securing EMT conduit segments.

FIG. 2 illustrates a side perspective view of a prior art coupling apparatus that utilizes tool fittings, a co-axial secondary bore, compression rings, etc.

FIG. 3 illustrates a side perspective view of a coupling apparatus in a ‘relaxed’ or ‘locking’ position that does not require tools to install according to an embodiment of the invention.

FIG. 4 illustrates a top perspective view of a coupling apparatus in a ‘relaxed’ or ‘locking’ position according to yet another embodiment of the invention.

FIG. 5 illustrates yet another side perspective view of a coupling apparatus in a ‘relaxed’ or ‘locking’ position according to an embodiment of the invention.

FIG. 6 illustrates a side perspective view of a coupling apparatus in a ‘relaxed’ or ‘locking’ position with EMT conduit lengths inserted into first and second flexible support arm opening respectively according to an embodiment of the invention.

FIG. 7 illustrates a side view of a coupling apparatus position for allowing a conduit length end to be inserted into a housing according to an embodiment of the invention.

FIG. 8 illustrates a side view of a coupling apparatus in a ‘non-relaxed’ or ‘non-locking’ position utilizing a wire assembly for allowing conduit lengths to be inserted into a housing and a warning tag according to an embodiment of the invention.

FIG. 9 illustrates a top view of a coupling apparatus stamped out of a flat plate according to an embodiment of the invention.

FIG. 10 illustrates that more than two conduit ends can be held by a coupling apparatus by adding any number of coupling apparatus sections according to yet another embodiment of the invention.

FIG. 11 illustrates a single coupling apparatus section with a mounting flange according to yet another embodiment of the invention.

FIG. 12 illustrates a coupling apparatus that can be formed into the shape of a ‘U-shaped’ coupling apparatus according to yet another embodiment of the invention

FIG. 13 illustrates a block diagram of a method for forming a coupling apparatus according to an embodiment of the invention.

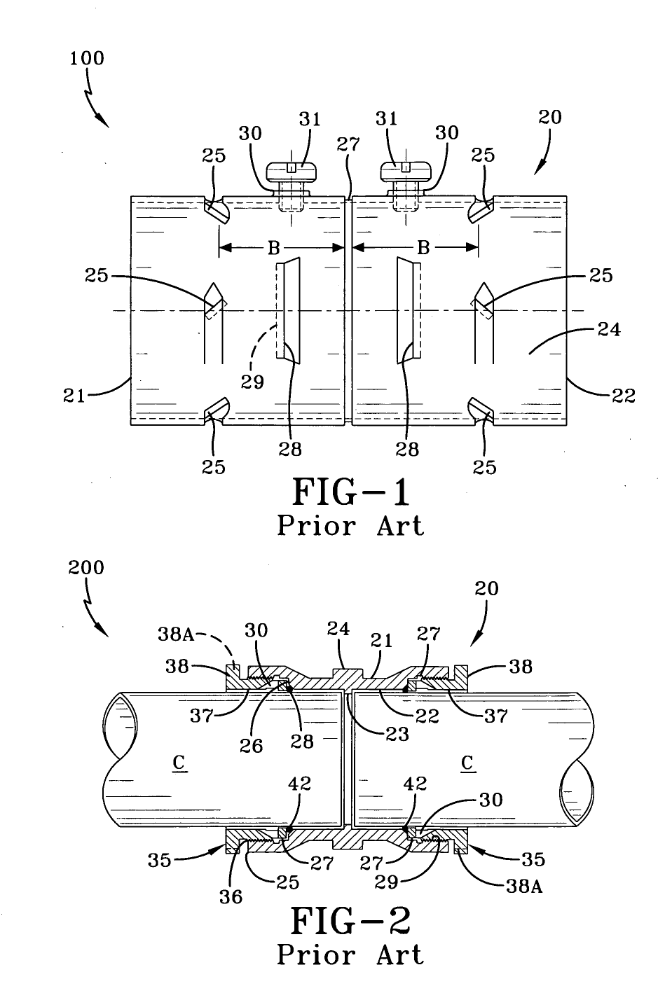

### DETAILED DESCRIPTION OF THE INVENTION

One or more implementations of the present invention will now be described with reference to the attached drawings, wherein like reference numerals are used to refer to like elements throughout. The invention relates generally to a coupling apparatus and method that is inexpensive, requires little effort or skill to install/remove; and is easy to inspect to determine if it installed properly.

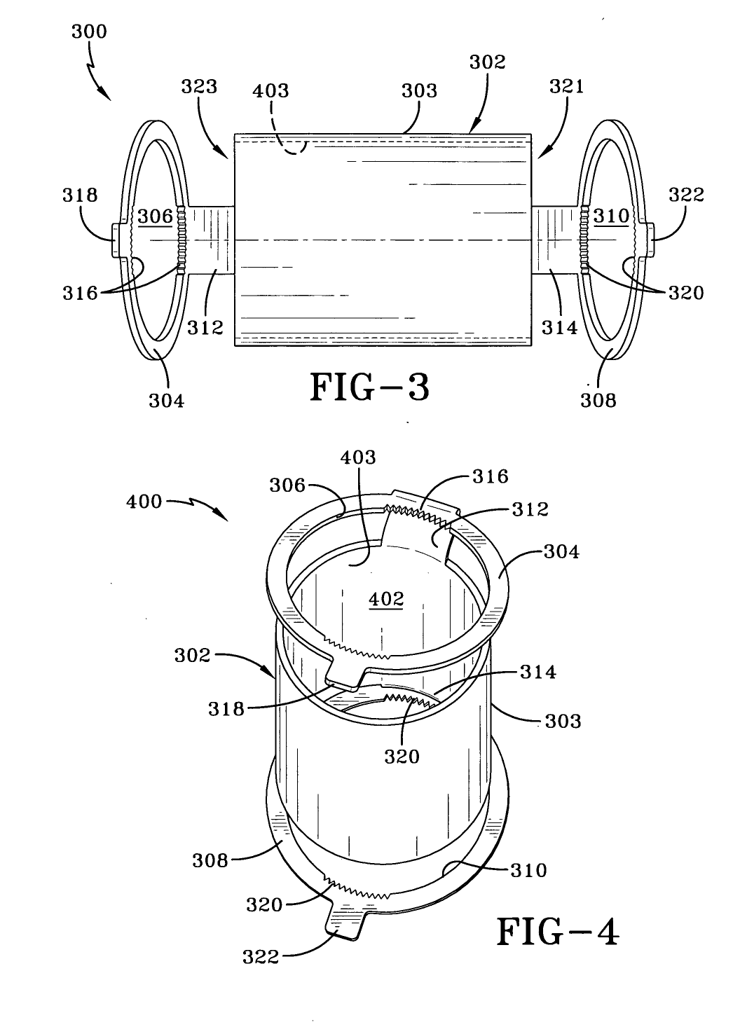

Referring now to the drawings, one embodiment of the invention is illustrated in FIGS. 3 and 4 which illustrate a side and top view, respectively of one embodiment of a novel expansion/contraction coupling apparatus 300 and 400 in a ‘relaxed’ position. It includes a central housing 302 with both an outer surface 303 and inner surface 403 which forms a central bore 402 (FIG. 4) sized to receive the ends of EMT conduit lengths being joined within the coupling apparatus 300 at a right coupling opening 321 and the coupling apparatus 300. The coupling apparatus 300 further comprises a first flexible support arm 304 with a first arm opening 306 that further comprises a first arm spring element 312 and a plurality of first arm teeth 316 designed to engage with and grip a first EMT conduit length wherein bonding and/or grounding effectiveness increases when a pulling force on the EMT conduit section is applied to the coupling apparatus 300. In addition, a second flexible support arm 308 with a second arm opening 310 that further comprises a second arm spring element 314 and a plurality of second arm teeth 320 designed to engage with and grip a second EMT conduit length end wherein again bonding and/or grounding effectiveness increases when the pulling force the EMT is applied to the coupling apparatus 300. The first and second flexible support arms 304 and 308 can be moved by pushing on a first and/or second finger/thumb tab, 318 and 322 to flex the first and/or second arm spring element, 312 and 314.

Although the first and/or the second finger/thumb tab, 318 and 322 are shown as small tabs, the tabs can be much larger in width, length and thickness as known by one of skill in the art. In addition, a plurality of tabs (not shown) may be located at any location around the first and the second flexible support arms 304 and 308 and are still within the scope of the invention. The inventor also recognizes that the coupling apparatus 300 may be manufactured without any tabs for reasons of economy.

The first flexible support arm 304 with the first arm opening 306 and the second flexible support arm 308 with the second arm opening 310 both act as ‘pinch plates’ to alternately pinch and/or be moved to release the EMT conduit lengths ends. Although the first arm opening 306 and the second arm opening 310 are illustrated to be of equal sizes, the inventor also envisioned central housing openings (not shown) of differing sizes wherein one side accepts a larger diameter EMT conduit length and another side accepts a smaller diameter EMT conduit length so that a step from the housing smaller diameter to the housing larger diameter is created within the housing opening.

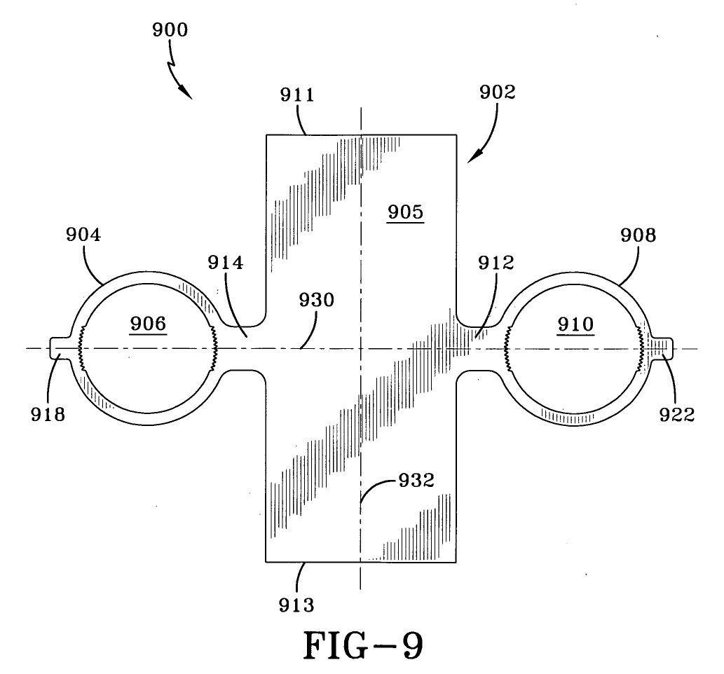

Additionally, a central series of indents/dimples or a cylindrical stop (not shown), for example can be created or machined into the smaller diameter housing near the housing center to act as a stop for the smaller diameter EMT conduit, or other techniques as known by those of skill in the art. Similarly, the central housings and arm openings can have various shapes comprising rectangles, ovals, hexagons, and the like, known by those of skill in the art. Also, the inventor envisioned housings than are tapered housings and alternatively flexible support arms that have unconnected parting line edges so that the coupling housing can be slipped over the conduit, with interlocking fingers, a surface that can be crimped in place, and other parts and techniques known by those of skill in the art to fasten the unconnected parting line edges together. In other words, the central housing 302 is not completely formed into a cylindrical shape. A first edge 911 is not connected to a second edge 913 (see e.g., FIG. 9).

A plurality of o-rings (not shown) can be added to the coupling apparatus 300, for example, as known by those of skill in the art to make the coupling apparatus 300 liquid tight, concrete tight and the like. In place of the o-ring, it is possible to bond an elastomeric sealing element/polymer, and the like known by those of skill in the art to make the coupling apparatus 300 liquid tight. In addition, the inventor envisioned a coupling apparatus 300 that permits the coupling and decoupling of conduit length from angles other than 180 degrees so that the run of EMT need not be parallel. For example, the coupling apparatus 300 can allow EMT conduit lengths to be connected at an angle of 90 degrees, in a u-shape, an s-shape, a tapered shape for connecting tapered conduit ends or other angles known by those of skill in the art.

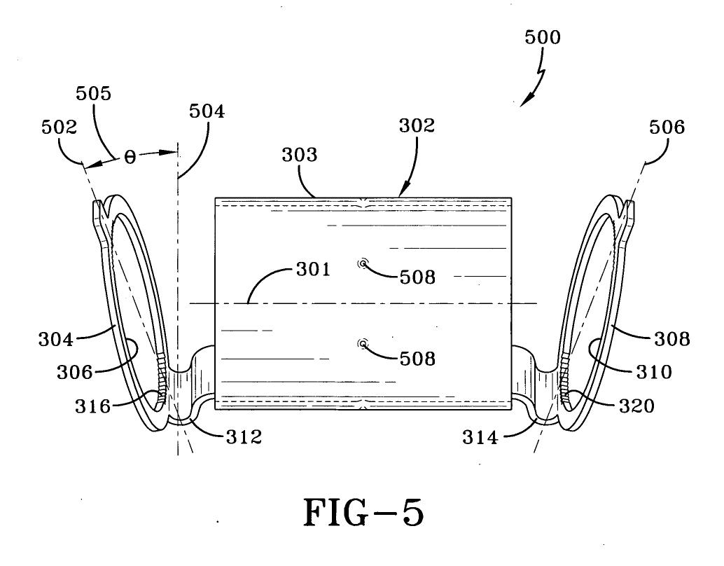

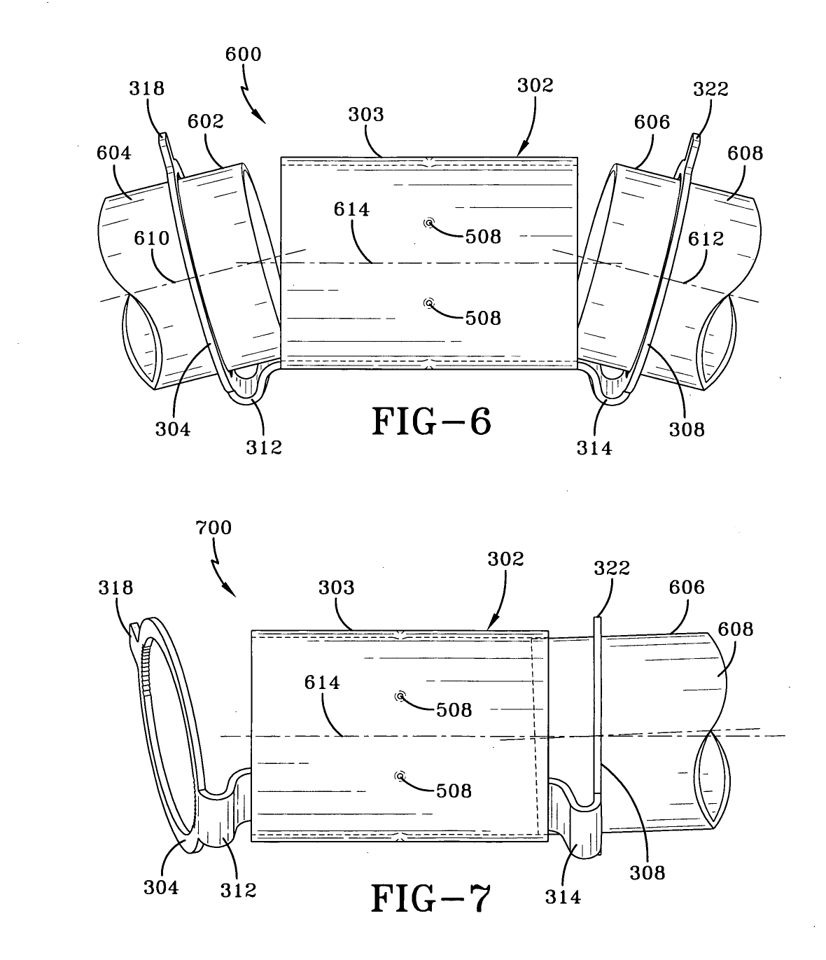

Referring to FIG. 5, a side view 500 of the expansion coupling apparatus 300 shown previously in FIG. 3 is illustrated in a ‘relaxed’ position comprising the central housing 302 with both the outer surface 303 and the inner surface which forms a central bore sized to receive ends of various EMT conduit lengths being joined within the coupling apparatus 300, as discussed above. A series of dimples 508 pressed or punched into the outer surface 303 can prevent the EMT conduit lengths from sliding past the midline of the housing 302. The coupling apparatus 300 further comprises the first flexible support arm 304 with the first arm opening 306 which itself further comprises the first arm spring element 312 and the plurality of optional first arm teeth 316 designed to engage with and grip the EMT conduit length end wherein bonding and/or grounding effectiveness increases when a pulling force on the EMT is applied to the coupling apparatus 300. A flexible support first and second arm axes 502 and 506 in the ‘relaxed’ position is preferably at an angle θ (505) between 11 and 22 degrees between the first and second arm axis 502 and 506 correspondingly with respect to a perpendicular axis 504 to the housing central axis (not shown). In addition, the second flexible support arm 308 with the second arm opening 310 further comprises the second arm spring element 314 and the plurality of optional second arm teeth 316 designed to engage with and grip the EMT conduit length wherein again bonding and/or grounding effectiveness increases when a pulling force on the EMT is applied to the coupling apparatus 300.

Although the angle θ (505) is illustrated as between 11 and 22 degrees, other angles can be employed by those of skill in the art, such as between 2 and 90 degrees. In addition, the first and second arms 304 and 308 may comprise complex angles with respect to the housing axis 301.

FIGS. 6 and 7 illustrate the operation of the coupling apparatus 300. As shown in illustration 600, a first conduit length first end 602 of a first conduit length 604 is inserted into the first flexible support arm 304 in the relaxed position. In addition, a second conduit length first end 606 of a second conduit length 608 is inserted into the second flexible support arm 308 in an ‘un-relaxed position”. As illustrated, a first conduit length axis 610 and a second conduit length axis 612 are not parallel to a housing axis 614. As illustrated, in FIG. 7 the second conduit length 608 can be inserted into the housing 302 by pushing on the second finger/thumb tab 322 until the second conduit length axis 612 is approximately parallel to the housing axis 614 and the second conduit length 608 can be slid into the housing until the second conduit length first end 606 is stopped by the series of dimples 508. The arm can then be

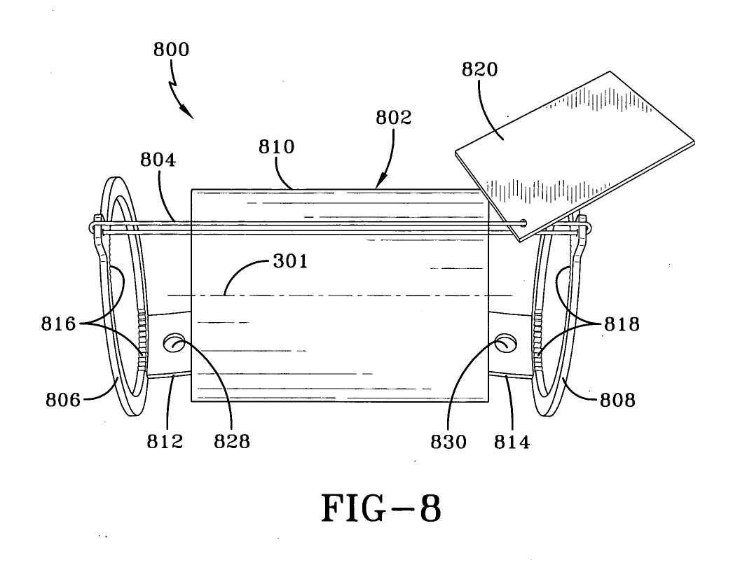

FIG. 8 illustrates yet another embodiment 800 of the present invention. As discussed supra, it is difficult to determine visually whether the prior art couplings with threaded fasteners are properly installed because the prior art devices provide no indication that the fasteners are locked in place properly with sufficient torque or even if they are locked at all. As illustrated in FIG. 8, a coupling apparatus 802 can be wired in an ‘unlocked’ position (or conduit receiving position) by tensioning a metal wire 804 so that it holds a first flexible support arm 806 and the second flexible support arm 808 in an ‘un-relaxed’ position so that various conduit ends can be inserted into a central housing 810. In other words, if the wire 804 is cut, the first flexible support arm 806 will spring back initially about a first arm spring element 812 in a counterclockwise direction and the second flexible support arm 808 will spring back about a second arm spring element 814 in a clockwise direction until it comes to a ‘locked’ position with various EMT conduit lengths (not shown) in place. In the ‘locked’ position, a plurality of optional first arm teeth 816 and a plurality of optional second arm teeth 818 engage with and grip the EMT conduit lengths wherein bonding and/or grounding effectiveness increases when a pulling force on the EMT conduit length is applied to the coupling apparatus 802. The inventor recognizes that a plurality of teeth is not necessary for a coupling apparatus to be effective. In addition, the inventor recognizes that fastening holes 828 and 830 can be formed in the coupling apparatus so that it can be mounted to a stud, for example. Although the fastening holes 828 and 830 are illustrated, many other mounting techniques are known by those of skill in the art.

It should be understood that the embodiment of the invention disclosed herein merely illustrate principles of the invention in a preferred form. Other modifications, additions and deletions may be made thereto without departure from the scope of the invention as set forth in the following claims.

Another embodiment of the invention is described in FIG. 9 which illustrates a top view of a stamped out flat plate prior to formation into the expansion coupling apparatus 300 as shown in FIG. 3.

In one embodiment, a first arm opening 906 and a second arm opening 910 is approximately 2.25 inches in diameter. A length and width of a first and/or second finger/thumb tab, 918 and 922 is approximately 0.375 inches. A width and a length of an inner/outer surface are approximately 3.25 inches and approximately 7.5 inches respectively. A distance between centers of a first arm opening 906 and a second arm opening 910 centers is 7.25 inches. The distance between an outside edge of a first and an outside edge of a second finger/thumb tab, 918 and 922 is approximately 10.6 inches. However one skilled in the art could modify the dimensions, for example to couple a cement sewer component 8 feet in diameter or greater, even smaller diameter conduit, for example one half inch, and the like known by those of skill in the art.

The coupling apparatus 900 includes a flat portion 902 that is formed into the central housing 302 of FIG. 3 with a outer surface (not shown) and inner surface 905, which when formed becomes the central bore 402 (FIG. 4) sized to receive the ends of EMT conduit lengths (not shown) being joined by the coupling apparatus 300 (FIG. 3). A first flexible support arm 904 with a first arm opening 906 that further comprises a first arm spring element 914 and a plurality of first arm teeth (316, FIG. 3) designed to engage with and grip the EMT conduit length wherein bonding and/or grounding effectiveness increases when a pulling force on the EMT is applied to the coupling apparatus 300. In addition, a second flexible support arm 908 with a second arm opening 910 that further comprises a second arm spring element 912 and a plurality of second arm teeth ((320, FIG. 3) are designed to engage with and grip various EMT conduit length ends wherein again bonding and/or grounding effectiveness increases when a pulling force on the EMT is applied to the coupling apparatus 300. The first and second flexible support arms 904 and 908 can be moved by pushing on a first and/or second finger/thumb tab, 918 and 922 to flex the first and/or second arm spring element, 914 and 912.

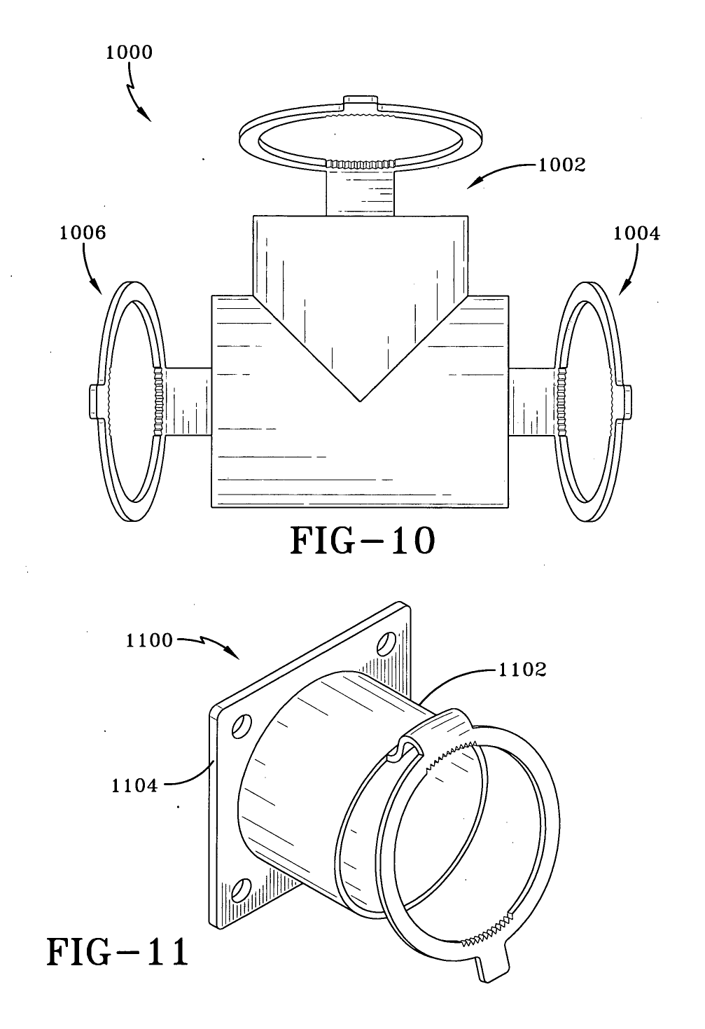

Although the first flexible support arm 904 and the second flexible support arm 908 are shown to be symmetrical with respect to axis 930, the inventor recognizes that the support arms 904, 908 do not have to be symmetrical about axis 930. In addition, the inventor recognizes that more than two conduit ends can be held by a coupling apparatus by adding any number of coupling apparatus sections (see e.g., FIG. 10, coupling apparatus sections, 1002, 1004 and 1006).

Although the first and/or the second finger/thumb tab, 918 and 922 are shown as small tabs, the tabs can be much larger in width, length and thickness as known by one of skill in the art. In addition, the first and/or the second finger/thumb tab, 918 and 922 can have various shapes comprising triangular, circular, oval, and the like and can be formed with hand grips, for example, made of and/or coated with materials comprising metal, plastic and the like, known by those of skill in the art. In addition, the coupling apparatus 300 can be made in various manufacturing processes comprising forgings, castings, stampings etc.

Referring to FIG. 10 a coupling apparatus 1000 can be formed to accept any number of conduit sections and/or pieces of pipe comprising those formed by techniques known by those of skill in the art. FIG. 11 illustrates a coupling apparatus 1100 formed to accept a single conduit section 1102 or object such as a flag pole, a support arm, etc. The other end of the coupling apparatus 1100 can comprise a mounting flange 1104, as shown.

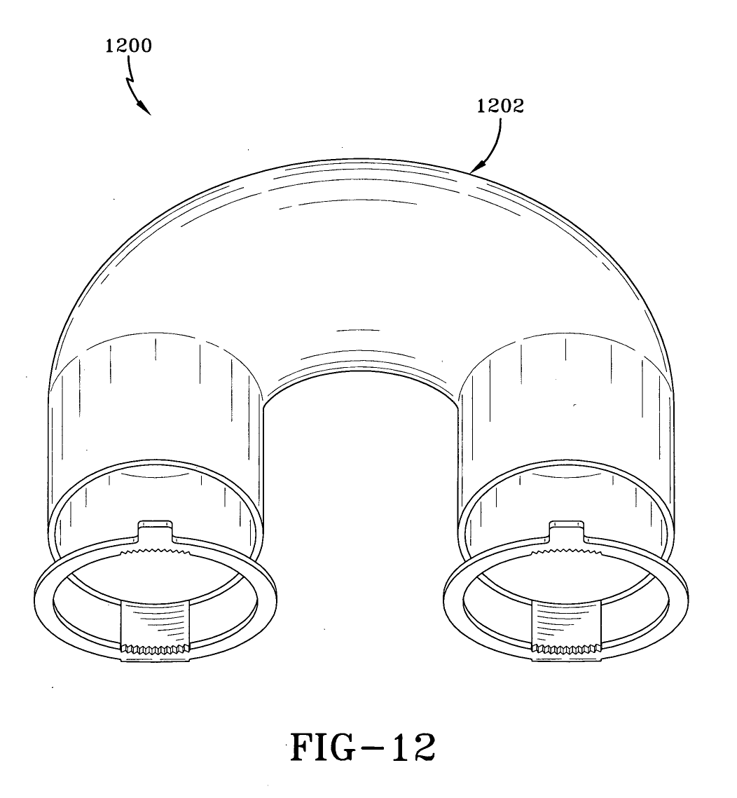

FIG. 12 illustrates yet another embodiment 1200 of a coupling apparatus 1202 in the present invention. As illustrated in FIG. 12 the coupling apparatus 1002 can be shaped in the form of the ‘U-shaped’ coupling apparatus 1200. One of skill in the art, can envision many shaped coupling apparatus with shapes comprising the letter “s”, an elbow, and the like.

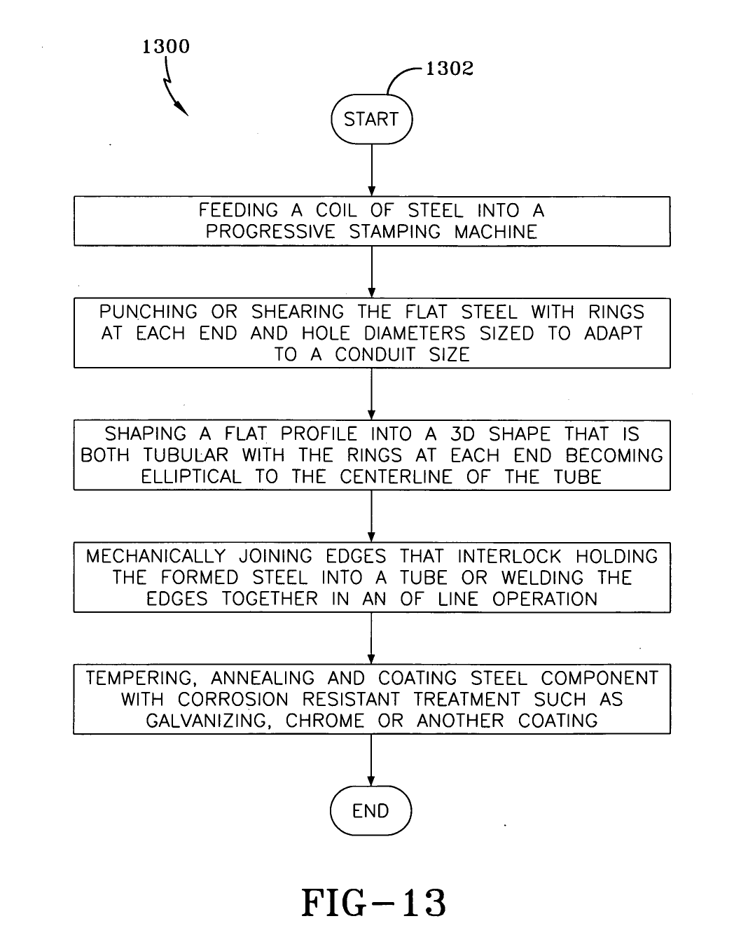

According to another exemplary aspect of the present invention, FIG. 13 is a schematic block diagram of an exemplary method 1300 illustrating one method of converting coiled carbon steel into couplings for joining pipe and conduit, for example. The explanation of method 1300 will refer to FIGS. 3 and 9. While exemplary methods are illustrated and described herein as a series of acts or events, it will be appreciated that the present invention is not limited by the illustrated ordering of such acts or events, as some may occur in different orders and/or concurrently with other steps apart from that shown and described herein, in accordance with the invention. In addition, not all illustrated steps may be required to implement a methodology in accordance with the present invention. Moreover, it will be appreciated that the methods may be implemented in association with the systems illustrated and described herein as well as in association with other systems not illustrated.

As illustrated in FIG. 13, the method 1300 begins at 1302 where a coil of carbon steel is feed into a progressive stamping machine. For example 1050 or 1075 carbon steel with a thickness of 0.025 inches can be utilized, which is then tempered, annealed and galvanized or coated for corrosion resistance with a 0.0005 thick coating, for example. Other thicknesses, known by those of skill in the art may be suitable depending on the diameter of the pipe or conduit being joined by the coupling 302.

The coil of the steel is fed into a progressive stamping machine with multiple stations. Each station in the progressive stamping machine has a function such as cutting, shearing, forming and bending, for example. The stamping machine functions as both a punch press and brake in that as the coil of steel is uncoiled and fed into the machine, the coiled steel first becomes a long strip much like unwinding a ribbon from its spool. Downstream from the unwinding coil, a series of dies e.g., first cuts (punches or shears) the flat steel into a flat profile that has the first and the second flexible support arm 904 and 908 (FIG. 9) at each end of the flat portion 902 that is formed into the central housing 302 of FIG. 3 of which is sized to adapt to various conduit sections. After the flat steel is cut, the following dies begin to shape the flat profile into a three dimensional shape that is both tubular in its center section with the first and the second flexible support arm 904 and 908 (FIG. 9) at each end of the flat portion 902 becoming elliptical to the centerline of the tube shape as the dies form the steel that attaches the first and the second flexible support arm 904 and 908 (FIG. 9) to the tube portion of the now formed profile.

The progressive stamping machine can have multiple ‘hits’, for example, as many hits as ninety per minute. With the progressive dies having multiple stations, for example nine stations to complete the cutting, forming, shaping and joining, each hit then will automatically do nine different functions simultaneously on the long flat ‘ribbon’ of steel as it passes through the dies in the machine. The entire operation of the nine stations within progressive stamping machine can, for example, be as short as two feet or as long as ten feet depending on the size-diameter of the various couplings being stamped.

As the cutting and forming take place within the progressive stamping machine changing the flat steel into a tubular shape, the edges of the flat steel are stamped in a way that allows opposing edges to come together and be mechanically joined as the edges may have puzzle like stamping shapes that interlock therefore holding the now formed steel into a tube for various couplings. Other methods of holding the central housing 302 together can do the same thing, such as welding the edges together in a second off line operation.

Once the ribbon of steel is converted into individual couplings, the various couplings are then tempered, annealed and coated with a suitable corrosion resistant treatment such as galvanizing, chrome or other coating. The annealing and tempering of the various couplings can convert the carbon steel into spring steel. The process, for example first heats the carbon steel to a temperature in the range of 1700 degrees F., then rapidly quenches the steel making it brittle. Then a tempering follows with the part being heated to 1400 degrees F. and then slowly the parts are air cooled. Environmental conditions and the type of carbon steel, say 1050 versus 1075 carbon steel may require more or less heat and time to anneal and temper. One skilled in the art could use suitable techniques or other known processes. After tempering and annealing, the corrosion resistant coating can be applied.

In addition, the invention contemplates a coupling being made from materials comprising spring steel, metals, conductive plastics, and the like. However if the coupling is not made in spring steel, it is possible to assemble the coupling onto the pipe, and then separate the first and the second flexible support arm 904 and 908 (FIG. 9) by releasing them with an angle necessary to insure that they lock the pipe into place. Then to disassemble the coupling 302, one would allow the flexible support arms 904 and 908 to move toward each other and therefore open to allow the pipe to pass through the flexible support arm opening(s). In addition, the support arms can be segmented prior to installation so that they have to be joined to form a continuous opening.

Although the invention has been illustrated and described with respect to one or more embodiments, implementations, alterations, and/or modifications may be made to the illustrated examples without departing from the spirit and scope of the following claims. In particular regard to the various functions performed by the above described components or structures (assemblies, devices, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”. “includes”, “having”, “has”, “with”, or variants thereof are used in either the detailed description and the claims, such terms are intended to be inclusive in a manner similar to the term “comprising”.

What is claimed is:

1. An coupling apparatus, comprising: a central housing with an outer surface and an inner surface; and
wherein the inner surface forms a central bore sized to receive an end of a first conduit length and an end of a second conduit length;
wherein the coupling apparatus further comprises a first and a second flexible support arm with a respective first and second arm opening that further comprises a respective first and second arm spring element and a plurality of first arm teeth and a plurality of second arm teeth that engage with and grip an end of a first conduit length and an end of a second conduit length;
wherein the bonding and/or grounding effectiveness of the end of a first conduit length and the coupling apparatus; and the end of a second conduit length and the coupling apparatus increases when a tensile force on the coupling apparatus increases by the increased separation of the end of the first conduit length and the end of a second conduit length.

2. The coupling apparatus of claim 1, wherein the plurality of the first and the second arm teeth respectively are one or greater; and
wherein the teeth shapes comprise v-shapes, rectangular shapes, barbs, notches, pins, serrations, non-uniform shapes, and comb teeth;
wherein the coupling apparatus comprises a flange and mounting holes for fastening the coupling apparatus to surfaces comprising a wall, a ceiling and a structural surface.

3. The coupling apparatus of claim 1, wherein a first plane of the first flexible support arm and a first plane of a second flexible support arm can be rotated with respect to a central housing axis by pushing on a first and/or second finger/thumb tab to flex the first and/or second arm spring element.

4. The coupling apparatus of claim 1, wherein the first and the second flexible support arms have the same size diameter first and second arm openings to connect the first and the second ends of the respective conduit lengths having the same diameter.

5. The coupling apparatus of claim 1, wherein the first and the second flexible support arms have different size diameter first and second arm openings to connect the respective ends of a first conduit length and a second conduit length having different outside diameters.

6. The coupling apparatus of claim 1, wherein the first and the second flexible support arm axes in the ‘relaxed’ position are at an angle θ between 11 and 22 degrees between the first and second arm axis correspondingly with respect to a perpendicular axis to the housing central axis.

7. The coupling apparatus of claim 6, wherein the first and the second flexible support arm axes in the ‘relaxed’ position are at an angle θ between 0 degrees and 90 degrees between the first and second arm axis correspondingly with respect to a perpendicular axis to the housing central axis.

8. The coupling apparatus of claim 1, wherein the coupling apparatus material comprises metal, spring steel, carbon steel, conductive plastic, plastic composites, flexible conductive ceramics, coated metals and a combination thereof;
wherein more than two coupling apparatus sections are formed in the coupling apparatus by adding any number of coupling apparatus sections or;
wherein a coupling apparatus formed with a single coupling apparatus section and a mounting end comprising a flange on an end opposite the single coupling apparatus section;
wherein the single coupling apparatus section holds an object comprising a flag, a support arm and a cylindrical hanger.

9. The coupling apparatus of claim 1, wherein the first and second flexible support arms can be moved by pushing on a first and/or second finger/thumb tab to flex the first and/or second arm spring element, wherein the first and/or second finger/thumb tab comprise various lengths, various widths, various thicknesses, various thicknesses, various hand grips, various attachment points for tools and hand grips with various plastic coverings.

10. The coupling apparatus of claim 1, wherein the coupling apparatus is manufactured in shapes comprising a letter “s”, a letter “u”, an elbow and a horseshoe, wherein the central housing, the coupling openings and the conduit lengths are formed in shapes comprising rectangles, triangles, ovals and hexagons.

11. The coupling apparatus of claim 1, wherein the coupling apparatus is effective in holding a variety of non-fixedly attached components, comprising water hose connections, spliced metal cable, spliced ropes, vacuum hoses, quick release tools, and concrete conduit length.

12. The coupling apparatus of claim 1, wherein the coupling apparatus is manufactured with materials comprising elastomeric materials, adhesives and polymers to make the coupling apparatus comprise a component that is liquid, water and concrete tight.

13. The coupling apparatus of claim 1, wherein the coupling apparatus first and second opening can comprise a circular shape, a rectangular shape and an oval shape; and
wherein the coupling apparatus holds materials comprising metal, concrete, plastic and wood.

14. A primary coupling apparatus comprising: a first central housing with an outer surface and an inner surface; and
wherein the inner surface forms a first central bore sized to receive at least an end of a first conduit length, an end of a second conduit length, and a at least a third conduit section with a respective central bore sized to receive an end of least a third conduit length;
wherein the primary coupling apparatus further comprises at least a first, a second, and a third flexible support arm with at least a respective first, second, and third arm opening that further comprise a respective first, second and third arm spring element, a plurality of first arm teeth, a plurality of second arm teeth and a plurality of third arm teeth that engage with and grip the end of a first conduit length, the end of a second conduit length and the end of the third conduit length;
wherein the bonding and/or grounding effectiveness of the coupling apparatus increases when a tensile force on the coupling apparatus increases.

15. A method for manufacturing a coupling apparatus comprising;
feeding a coil of steel into a progressive stamping machine;
punching or shearing the flat steel with rings at each end and hole diameters sized to adapt to a conduit size;
shaping a flat profile into a three dimensional shape that is tubular with the rings at each end becoming elliptical to the centerline of the tube;
mechanically joining edges that interlock holding the formed steel into a tube or welding the edges together in an off line operation; and
tempering, annealing and coating steel component with corrosion resistant treatment such a galvanizing, chrome or another coating.

16. The method of claim 15, wherein a flexible support first and a second arm axes in the ‘relaxed’ position is at an angle θ between 11 and 22 degrees between a first and second arm axis correspondingly with respect to a perpendicular axis to a housing central axis.

17. The method of claim 15, wherein a coupling apparatus material comprises metal, spring steel, carbon steel, conductive plastic, plastic composites, flexible conductive ceramics, coated metals and/or a combination thereof.

18. The method of claim 15, wherein a first and second flexible support arms and can be moved by pushing on a first and/or second finger/thumb tab, and to flex the first and/or second arm spring element, wherein the first and/or second finger/thumb tab, comprises multiple lengths, multiple widths, multiple thicknesses, variable thicknesses, hand grips, attachment points for tools and hand grips with plastic coverings.

19. The method of claim 15, wherein a flexible support first and a second arm axes' in the ‘relaxed’ position are at an angle between 2 and 90 degrees between the first and second arm axis correspondingly with respect to a perpendicular axis to the housing central axis.

20. The method of claim 15, wherein the coupling apparatus is manufactured in various shapes comprising a letter “s”, a letter “u”, an elbow and a horseshoe wherein the central housing, the coupling openings and the conduit lengths are formed in shapes comprising rectangles, triangles, ovals and hexagons.
